(19) United States
(12) Patent Application Publication
(10) Pub. No.: US 2004/0157964 A1
(43) Pub. Date: Aug. 12, 2004

(54) Vibration-damping composition and process for producing vibration-damping composition

(76) Inventors: Tatsuya Aoki, Seki-shi (JP); Takuya Satoh, Seki-shi (JP)

Correspondence Address: David M Crompton, Crompton Seager & Tufte, Suite 800, 1221 Nicollet Avenue, Minneapolis, MN, 55403-2420, US

(21) Appl. No.: 10/465,936

(22) PCT Filed: Mar. 28, 2002
(86) PCT No.: PCT/JP02/03105

(51) Int. Cl. C08K 5/46

(52) U.S. Cl. 524/83; 524/270

(57) ABSTRACT

A damping composition contains a base material in the form of a mixture of ethylene-methacrylate copolymer and rosin resin, and an active ingredient contained in the base material for increasing the dipole moment of the base material. The weight ratio of ethylene-methacrylate copolymer and rosin resin (EM:rosin) is 70:30 to 30:70.

### TECHNICAL FIELD

The present invention relates to a damping composition, and a method for producing the same, which is applied to automobiles, building interior materials, construction materials, or home appliances and so forth, that absorbs the vibration energy of vibration generation sources such as motors.

### BACKGROUND ART

In general, substances that absorb vibration energy, namely damping compositions, are formed from a soft vinyl chloride-based resin in which a plasticizer has been added to a vinyl chloride-based resin. In the “energy conversion composition” disclosed in International Patent Application No. WO97/42844, the vibration energy absorption performance (damping performance) of a damping molding is improved by adding an active ingredient to a base material in order to increase the amount of dipole moment in a base material composed of a vinyl chloride resin. A damping composition is used in the form of a damping composition molded into the shape of a sheet or block. In consideration of environmental issues, damping compositions are also known among synthetic resins in which an ethylene-methacrylate copolymer is used as the base material.

In the case of the prior art as described above, it is considered that in a damping composition in which an ethylene-methacrylate copolymer is used for the base material, the active ingredient is poorly compatible with the base material. Consequently, adequate damping performance was unable to be obtained with conventional damping compositions. In addition, damping moldings obtained from damping compositions cracked easily due to their hardness.

### DISCLOSURE OF THE INVENTION

An object of the present invention is to provide a damping composition, and a method for producing the same, that enables the obtaining of adequate damping performance.

The following damping composition is provided in order to achieve the above object. The damping composition contains as a base material a mixture containing an ethylene-methacrylate copolymer and a rosin resin at a weight ratio of 70:30 to 30:70, and an active ingredient that increases the dipole moment of the base material within the base material.

Moreover, the present invention provides the following production method of a damping composition. The damping composition contains a base material and an active ingredient for increasing the dipole moment of the base material within the base material. The production method of this damping composition includes the preparation of a base material by mixing an ethylene-methacrylate copolymer and a rosin resin at a weight ratio of 70:30 to 30:70.

### BEST MODE FOR CARRYING OUT THE INVENTION

The following provides an explanation of a damping composition of one embodiment that embodies the present invention.

The damping composition in the present embodiment uses for its base material a mixture of an ethylene-methacrylate copolymer (EM) and a rosin resin. An active ingredient is contained in the base material so as to increase the dipole moment of the base material. A styrene-butadiene rubber (SBR) or an ethylene-vinyl acetate (EVA) polymer is preferably contained in the base material.

The weight ratio of EM and rosin (EM:rosin) is from 70:30 to 30:70. If the ratio of rosin is increased beyond this range, it becomes difficult to mold the damping composition. On the other hand, if the ratio of EM is increased beyond this range, adequate damping performance cannot be obtained for the damping composition. EM and rosin are preferably mixed at a weight ratio from 50:50 to 35:65. If the ratio of rosin is increased beyond this range, there is the risk of it becoming difficult to mold the damping composition. On the other hand, if the ratio of EM is increased beyond this range, there is the risk of adequate damping performance being unable to be obtained for the damping composition.

EM represents a copolymer of ethylene monomer and methacrylate monomer. Examples of methacrylate monomers that are used include methacrylic acid, methacrylate esters, methacrylate chloride, diethylaminoethyl methacrylate, dimethylaminoethyl methacrylate, lauryl methacrylate, glycidyl methacrylate, and 2-hydroxyethyl methacrylate. Examples of methacrylate esters used include methyl methacrylate, isobutyl methacrylate, and n-butyl methacrylate. One type or two or more types of these methacrylate monomers may be used for EM. Among these EM, an ethylene-methacrylate copolymer is particularly preferable due to its ease of acquisition.

Rosin is blended to improve the damping performance of the damping composition as well as improve brittleness. Rosin has abietic acid as its main ingredient, and is equivalent to gum rosin, wood rosin, tall oil resin, and their derivatives. One type or two or more types of these rosins may be used. Examples of derivatives of gum rosin that are used include hydrogenated rosin, dismutated rosin, polymerized rosin, and ester rubber. Furthermore, when selecting the rosin, compatibility between the rosin and EM, namely solubility parameter (SP), is taken into consideration, and those with similar values are selected.

The active ingredient is blended in order to improve the damping performance of the damping composition by increasing the dipole moment in the base material. Examples of active ingredients used include compounds having a benzothiazyl group, compounds having a benzotriazole group, compounds having a diphenylacrylate group, and compounds having a benzophenone group. Examples of compounds having a benzothiazyl group that are used include N,N-dicyclohexylbenzothiazyl-2-sulfenamide (DCHBSA), 2-mercaptobenzothiazole (MBT), dibenzothiazylsulfide, N-cyclohexylbenzothiazyl-2-sulfenamide (CBS), N-tert-butylbenzothiazyl-2-sulfenamide (BBS), N-oxydiethylenebenzothiazyl-2-sulfenamide (OBS), and N,N-diisopropylbenzothiazyl-2-sulfenamide (DPBS).

Examples of compounds having a benzotriazole group that are used include 2-{2′-hydroxy-3′-(3″,4″,5″,6″-tetrahydrophthalimidomethyl)-5′-methylphenyl}-benzotriazole (2HPMMB), 2-{2′-hydroxy-5′-methylphenyl}-benzotriazole (2HMPB), 2-{2′-hydroxy-3′-t-butyl-5′-methylphenyl}-5-chlorobenzotriazole (2HBMPCB), and 2-{2′-hydroxy-3′,5′-di-t-butylphenyl}-5-chlorobenzotriazole (2HDBPCB) having a benzotriazole as a core, in which an azole group is bonded to a benzene ring, and a phenyl group bonded thereto.

As the compounds having a diphenyl acrylate group, ethyl-2-cyano-3,3-diphenyl acrylate is used.

Examples of compounds having a benzophenone group include 2-hydroxy-4-methoxybenzophenone (HMBP) and 2-hydroxy-4-methoxybenzophenone-5-sulfonic acid (HMBPS).

In the case of blending these compounds into the base material, one type or two or more types selected from among these may be used. It should be noted that when selecting the active ingredient, compatibility between the active ingredient and the base material, namely the solubility parameter (SP), is taken into consideration, and those having similar values are selected.

Among these active ingredients, at least one type selected from compounds having a benzothiazyl group, compounds having a benzotriazole group, and compounds having a diphenyl acrylate group are preferable since they have superior action of increasing the dipole moment in the base material.

The blended amount of active ingredient is preferably a ratio of 10 to 250 parts by weight, and more preferably 50 to 150 parts by weight, relative to 100 parts by weight of the base material. If the blended amount is less than 10 parts by weight, the action of increasing the dipole moment is not adequately obtained. On the other hand, if the blended amount exceeds 250 parts by weight, there is the risk of problems occurring such as the active ingredient being unable to be adequately compatible with the base material.

SBR imparts flexibility to EM, and is preferably blended to improve the moldability of the damping composition. The ratio of styrene that composes the SBR is preferably 20 to 65%. If the ratio of styrene is less than 20%, there is the risk of decreasing the damping performance. On the other hand, if the ratio of styrene exceeds 65%, there is the risk of the effect of improving moldability being unable to be adequately obtained. The weight ratio of EM and SBR is preferably within the range of 1:1 to 15:1. On the other hand, if the ratio of SBR is increased, although the flexibility and workability of the damping composition become higher, there is the risk of decreasing the damping performance of the damping composition.

EVA imparts flexibility to EM, and is preferably blended to improve moldability of the damping composition. The ratio of vinyl acetate that composes the EVA is preferably 10 to 50%. If the ratio of vinyl acetate is less than 10%, there is the risk of the effect of improving moldability being unable to be adequately obtained. On the other hand, if the ratio of vinyl acetate exceeds 50%, in addition to the fact that it becomes difficult to acquire, there is also the risk of higher costs. The weight ratio of EM and EVA is preferably within the range of 1:1 to 15:1. If the ratio of EM is increased beyond this range, there is the risk of the flexibility and workability of the damping composition decreasing. On the other hand, if the ratio of EVA is increased, although flexibility increases and forming becomes easier, there is the risk of decreasing the damping performance.

Other components such as filler, flame retardant, corrosion preventive, colorant, antioxidant, antistatic, stabilizer, lubricant, and so forth may be suitably added to the base material as necessary.

In addition to improving damping performance, a filler is blended to serve as a reinforcing agent, heat resistance agent, and thickener. Examples of fillers include carbon black, silica, mica scales, glass fragments, glass fiber, carbon fiber, calcium carbonate, barite, and precipitated barium sulfate.

The damping composition is prepared by a roll kneading method in which a base material and an active ingredient are mixed by roll kneading. A kneading apparatus such as a hot roller, Banbury mixer, biaxial kneader, or extruder is used for molten kneading of the base material and active ingredient by a roll kneading method. A damping molding can be obtained by molding the prepared damping composition into the shape of a sheet or block and so forth by a molding machine such as a press, extruder, and T-die.

The resulting damping molding can be applied to automobiles, building interior materials, construction materials or home appliances and so forth, and is able to absorb vibration energy of motors and other vibration generation sources. Furthermore, the damping performance of the damping molding is known to be better the larger the value of the loss coefficient (η) or loss tangent (tanδ).

A vibration molding such as an unrestrained damping sheet can be obtained by molding the damping composition into the shape of a sheet. One side of an unrestrained damping sheet is not restrained when the sheet is laminated to an application site.

A restrained damping sheet can be obtained by using a damping composition molded into the shape of a sheet as a damping layer, and laminating a restraining layer for restraining that damping layer onto the surface of that damping layer. Metal foils such as aluminum and lead, films formed from synthetic resins such as polyethylene and polyester, and non-woven fabrics are used for the restraining layer. Both sides of a restrained damping sheet are restrained by laminating the damping layer side of the sheet to an application site.

In the case of producing a damping composition, the base material, active ingredient, and other components are loaded into a kneading apparatus. Next, a damping composition is produced by heating and kneading each material. At this time, the compatibility between EM and active ingredient is thought to be improved by the rosin.

Next, the damping composition is molded by a molding machine to obtain a damping molding. At this time, if SBR or EVA is blended into the base material, flexibility is imparted to the EM in the base material, and the moldability of the damping composition can be improved. The damping molding is used by laminating at a location that requires insulation or alleviation of the transmission of vibrations from a vibration generation source. At this time, since the rosin blended into the damping composition has the action of improving brittleness, problems such as cracking of the damping molding can be suppressed.

Vibrations generated from a vibration generation source are transmitted to the damping molding in the form of vibration energy. The dipole moment in the base material is increased by the active ingredient blended into the damping molding. The active ingredient acts on the intermolecular constraining force of the EM in the base material in the form of a dipole, and is arranged in a stable state within the base material. When vibration energy is applied to the damping molding from the outside, displacement occurs in the dipole causing the dipole to enter an unstable state. However, the dipole attempts to return to the stable state prior to the application of vibration energy. At this time, energy consumption occurs and the damping molding is therefore thought to be able to absorb the vibration energy.

In addition, the compatibility between EM and active ingredient is thought to be improved by the rosin blended into the damping composition. Thus, the active ingredient is thought to allow the constraining force to act more strongly between the molecules of EM. Consequently, when vibration energy is applied to the damping molding from the outside, the dipole displacement becomes larger, and this is thought to improve the damping performance of the damping molding.

The present embodiment has the effects described below.

A mixture of EM and rosin is used for the base material, and an active ingredient that increases the dipole moment of the base material is contained in the base material. In the present embodiment, EM and rosin are mixed at a ratio of 70:30 to 30:70, and more preferably, 50:50 to 35:65. According to this composition, compatibility between EM and the active ingredient is thought to be improved by the rosin. Moreover, fragility of the damping composition is improved by the rosin. Thus, damping performance of the damping composition can be adequately obtained, and problems such as cracking can be suppressed.

The active ingredient is at least one type of compound having a benzothiazyl group, compound having a benzotriazole group, or compound having a diphenyl acrylate group. Thus, the dipole moment in the base material can be efficiently increased, and damping performance can be more adequately obtained.

The content of the active ingredient relative to the base material is 10 to 250 parts by weight relative to 100 parts by weight of the base material. According to this composition, since the dipole moment in the base material can be adequately increased, damping performance can be more adequately obtained.

A styrene-butadiene copolymer rubber is contained in the base material of the damping composition. According to this composition, since flexibility is imparted to EM, the moldability of the damping composition can be improved.

An ethylene-vinyl acetate copolymer is contained in the damping composition. According to this composition, since flexibility is imparted to EM, the moldability of the damping composition can be improved.

Next, the following provides a more detailed explanation of the above embodiment using examples and comparative examples.

### EXAMPLES 1 to 5 and COMPARATIVE EXAMPLES 1 and 2

EM (Nucrel AN4213C, Du Pont-Mitsui Polychemicals) and rosin (Ultra-Light-Colored Rosin KR-610, Arakawa Chemical Industries) were loaded into a roll kneader at the ratios shown in Table 1 to serve as the base material. Moreover, DCHBSA (Sansera DZ, Sanshin Chemical Industry), SBR (NIPOL 9529, styrene content: 45%, Zeon Corporation), mica scales (Kuralite Mica 60-C, Kuraray) and a flame retardant (Polysafe FCP-9, Ajinomoto-Fine-Techno) were loaded into the roll kneader. Kneading was then carried out for 10 minutes at a temperature of 140° C. to prepare a damping composition.

### EXAMPLES 6 AND 7

As shown in Table 1, damping compositions were prepared in the same manner as Examples 1 through 5 described above by blending EVA (EVA 45LX (vinyl acetate content: 46%), Du Pont-Mitsui Polychemicals) instead of SBR.

### EXAMPLES 8 and 9 and COMPARATIVE EXAMPLE 3

As shown in Table 1, damping compositions were prepared in the same manner as Examples 1 through 5 described above except that no SBR was blended in the composition.

The blended amounts of the raw materials in the above Examples 1 through 9 and Comparative Examples 1 through 3 are shown in Table 1 in terms of parts by weight.

TABLE 1
(Weight ratio)

| | | | | | | Mica | Flame |
|---|---|---|---|---|---|---|---|
| | EM | Rosin | DCHBSA | SBR | EVA | scales | retardant |
| Example 1 | 10.5 | 4.5 | 15.0 | 5 | — | 70 | 14 |
| Example 2 | 9.0 | 6.0 | 15.0 | 5 | — | 70 | 14 |
| Example 3 | 7.5 | 7.5 | 15.0 | 5 | — | 70 | 14 |
| Example 4 | 6.0 | 9.0 | 15.0 | 5 | — | 70 | 14 |
| Example 5 | 4.5 | 10.5 | 15.0 | 5 | — | 70 | 14 |
| Example 6 | 6.0 | 9.0 | 15.0 | — | 5 | 70 | 14 |
| Example 7 | 6.0 | 9.0 | 15.0 | — | 3 | 70 | 14 |
| Example 8 | 7.5 | 7.5 | 15.0 | — | — | 70 | 14 |
| Example 9 | 6.0 | 9.0 | 15.0 | — | — | 70 | 14 |
| Comparative | 12.0 | 3.0 | 15.0 | 5 | — | 70 | 14 |
| Example 1 | | | | | | | |
| Comparative | 15.0 | — | 15.0 | 5 | — | 70 | 14 |
| Example 2 | | | | | | | |
| Comparative | 15.0 | — | 15.0 | — | — | 70 | 14 |
| Example 3 | | | | | | | |

The damping compositions obtained in Examples 1 through 9 and Comparative Examples 1 through 3 were placed in a press and press working was conducted for 5 minutes under conditions of pressure of 7845 kPa and temperature of 100° C. Subsequently, the damping compositions were molded into the shape of sheets having a thickness of 0.8 mm to obtain damping moldings (unrestrained damping sheets). Since SBR was blended into Examples 1 through 5 and EVA was blended into Examples 6 and 7, the compositions were easily able to be molded into sheets.

These damping moldings were cut to dimensions of 156×15 mm, and used as test pieces for measurement of loss coefficient. In addition, each damping molding was cut to dimensions of 25×25 mm, and 10 sheets were superposed on each other for use as test pieces for measurement of hardness.

The peak of the initial resonance frequency when these test pieces were vibrated, namely the loss coefficient in the primary mode of the resonance frequency, was calculated using a center vibrating-type loss coefficient measuring apparatus (Model CF5200, Ono Sokki), followed by determination of the maximum value of the loss coefficient. The center supported stationary vibration method is a method in which the loss coefficient is determined by measuring the impedance at a vibrating point in the center of the test piece using a mechanical impedance measuring instrument.

In addition, the type A durometer hardness of each test piece was measured using a type A durometer hardness meter in compliance with JIS K 6253. In this case, measurements were performed by pressing the pushing pin and vibrating surface against the surface of the test piece. The spring-driven pushing pin was moved so as to cause deformation of the test piece. The pushing pin was stopped when the force applied by the spring balanced the elastic force of the test piece. The amount of movement of the pushing pin at this time is equivalent to the “hardness” of the test piece.

The measurement results of Examples 1 through 9 and Comparative Examples 1 through 3 are shown in Table 2.

TABLE 2

| | Loss coefficient | Hardness |
|---|---|---|
| Example 1 | 0.191 | 91 |
| Example 2 | 0.198 | 91 |
| Example 3 | 0.203 | 90 |
| Example 4 | 0.222 | 90 |
| Example 5 | 0.204 | 89 |
| Example 6 | 0.202 | 88 |
| Example 7 | 0.210 | 89 |
| Example 8 | 0.211 | 90 |
| Example 9 | 0.205 | 92 |
| Comparative | 0.187 | 91 |
| Example 1 | | |
| Comparative | 0.160 | 95 |
| Example 2 | | |
| Comparative | 0.175 | 95 |
| Example 3 | | |

As shown in Table 2, the loss coefficients of Examples 1 through 9 exhibited larger values than the loss coefficients of Comparative Examples 1 through 3. This indicates that the damping performance of the damping moldings of Examples 1 through 9 is superior to the damping performance of the damping moldings of Comparative Examples 1 through 3. In addition, the hardness values of Examples 1 through 9 exhibited smaller values than the hardness values of Comparative Examples 2 and 3. This indicates that the damping moldings of Examples 1 through 9 are more resistant to cracking than the damping moldings of Comparative Examples 2 and 3.

The damping composition of Comparative Example 1 contains rosin. Consequently, the hardness of Comparative Example 1 exhibits a value that is smaller than the hardness values of Comparative Examples 2 and 3. Thus, the damping molding of Comparative Example 1 is more resistant to cracking than the damping moldings of Comparative Examples 2 and 3 in the same manner as the damping moldings of Examples 1 through 9. However, the loss coefficient of Comparative Example 1 exhibits a value that is slightly lower than the loss coefficients of Examples 1 through 9. Consequently, it can be seen that, in the case of the damping molding of Comparative Example 1, adequate damping performance is unable to be obtained in comparison with the damping moldings of Examples 1 through 9.

Furthermore, the embodiment may be modified in the manner described below.

The damping composition of the present embodiment may also be used as an acoustic absorption molding. Acoustic absorption moldings are able to absorb sound transmitted through the air (sound energy). Thus, acoustic absorption moldings may be applied to automobiles, building interior materials, construction materials or home appliances and so forth to absorb sound transmitted through the air of noise generation sources. In addition, the damping composition of the present embodiment may also be used as an impact-absorbing molding. Impact-absorbing moldings are able to absorb the force of an impact (impact energy). Thus, impact-absorbing moldings may be applied to walls, fences, helmets, vehicles or airplanes and so forth to absorb the force of impact of impact generation sources.

Rubber other than SBR, such as acrylonitrile-butadiene rubber (NBR) or silicone rubber, may also be blended into the damping composition. In addition, thermoplastic elastomers such as polyurethane-based and polyolefin-based thermoplastic elastomers may also be blended.

Adhesion-imparting resins other than rosin, such as dammar resin and terpene, may also be blended into the damping composition.

1. A damping composition comprising: a base material in the form of a mixture containing an ethylene-methacrylate copolymer and a rosin resin at a weight ratio of 70:30 to 30:70, and an active ingredient for increasing the dipole moment of the base material contained in the base material.

2. The damping composition according to claim 1, wherein the weight ratio of ethylene-methacrylate copolymer and rosin resin is from 50:50 to 35:65.

3. The damping composition according to claim 1 or 2, wherein the active ingredient is at least one compound selected from a compound having a benzothiazyl group, a compound having a benzotriazole group, and a compound having a diphenyl acrylate group.

4. The damping composition according to any one of claims 1 through 3, wherein the content of the active ingredient in the base material is 10 to 250 parts by weight of active ingredient relative to 100 parts by weight of base material.

5. The damping composition according to any one of claims 1 through 4, wherein styrene-butadiene copolymer rubber is contained in the base material.

6. The damping composition according to any one of claims 1 through 5, wherein an ethylene-vinyl acetate copolymer is contained in the base material.

7. A method for producing a damping composition that contains a base material, and an active ingredient for increasing the dipole moment of the base material in the base material, the method comprising preparing the base material by mixing an ethylene-methacrylate copolymer and a rosin resin at a ratio of 70:30 to 30:70 in terms of weight ratio.

8. The method for producing a damping composition according to claim 7, wherein the weight ratio of the ethylene-methacrylate copolymer to the rosin resin is from 50:50 to 35:65.

9. The method for producing a damping composition according to claim 7 or 8, wherein the active ingredient is at least one compound selected from a compound having a benzothiazyl group, a compound having a benzotriazole group, and a compound having a diphenyl acrylate group.

10. The method for producing a damping composition according to any one of claims 7 through 9, wherein the content of the active ingredient in the base material is 10 to 250 parts by weight of active ingredient relative to 100 parts by weight of base material.

11. The method for producing a damping composition according to any one of claims 7 through 10, wherein styrene-butadiene copolymer rubber is contained in the base material.

12. The method for producing a damping composition according to any one of claims 7 through 11, wherein an ethylene-vinyl acetate copolymer is contained in the base material.
